(19) United States
(12) Patent Application Publication
(10) Pub. No.: US 2004/0223299 A1
(43) Pub. Date: Nov. 11, 2004

(54) Display cooling

(76) Inventor: Prosenjit Ghosh, Portland, OR (US)

Correspondence Address: INTEL CORPORATION, P.O. BOX 5326, SANTA CLARA, CA, 95056-5326, US

(21) Appl. No.: 10/434,257

(22) Filed: May 7, 2003

(51) Int. Cl. G06F 1/20

(52) U.S. Cl. 361/687

(57) ABSTRACT

Apparatus and method for cooling a display unit includes having a first set of one or more openings to allow pressured air to enter a display unit housing and a second set of one or more openings to allow the air to exit. The pressured air is generated by an air movement device. The air movement device may be internal or external to the display unit housing.

### FIELD OF THE INVENTION

The present invention relates to the field of thermal management, and more particularly, to heat removal from a computing device.

### BACKGROUND

Smaller and more powerful electronic components allow for the design and construction of higher performance portable computing devices (e.g., laptop or notebook computers). Unfortunately, the use of such powerful electronic components often results in increased heat generation. Thus, heat dissipation technology is often used to maintain operating temperatures of the computing devices.

A portable computing device typically includes a base unit and a display unit. The base unit usually includes an input device (e.g., a keyboard or a touchpad) and a number of electronic components (e.g., processor, disk drive, memory modules, etc.). When in operation, each of these electronic components may generate a different amount of heat. In addition, the display unit may also generate a certain amount of heat when being active for a period of time.

Maintaining the temperatures of the electronic components and of the display is important to ensure performance, reliability, and safety. Most integrated circuits have specified maximum operating temperatures. When the temperature exceeds a specified maximum, the electronic component may fail. Typically, the base unit may include a fan employed to dissipate heat from the electronic components. The fan may be located in the rear wall of the base unit and may be constructed to induce airflow across the various electronic components in the base unit.

When the display is intergrated into the base unit (e.g., a tablet-like construction), the airflow induced by the fan in the base unit may also help cool the display unit. However, when the display unit is attached to the base unit (e.g., a clamshell-like construction), the airflow in the base unit may have minimal effect on the heat generated by the display unit. In a portable computing device, the display unit is normally thin and display cooling is typically passive. Keeping the display unit cool may help increase its reliability and reduce power consumption of the portable computing device.

### BRIEF DESCRIPTION OF THE FIGURES

The present invention is illustrated by way of example and not limitation in the figures of the accompanying drawings.

FIGS. 1A and 1B illustrate a side view and a front view of a prior art portable computing device.

FIGS. 2A and 2B illustrate a side view and a front view of a portable computing device that includes an air movement device to cool a display unit, according to one embodiment.

FIG. 3 illustrates a side view of another portable computing device that includes an air movement device to cool a display unit, according to one embodiment.

FIG. 4 illustrates a tablet computing device, according to one embodiment.

FIG. 5 illustrates a tablet computing device that includes openings to receive pressured airflow, according to one embodiment.

FIG. 6 illustrates a third tablet computing device that includes openings to enable pressured airflow to enter, according to one embodiment.

FIG. 7 illustrates a tablet computing device with an air movement device, according to one embodiment.

FIG. 8 is a flow diagram illustrating an example of a process used to cool a display unit of a computing device, according to one embodiment.

FIG. 9 is a flow diagram illustrating another process used to cool a display of a computing device, according to one embodiment.

### DETAILED DESCRIPTION

For one embodiment, a method for cooling a display unit is disclosed. The display unit may include a housing and a display screen. The housing may include one or more openings. Airflow is blown through the one or more openings into the housing of the display unit using an active cooling device external to the display unit.

In the following description, numerous specific details, such as component types, heat dissipation device sizes, and heat dissipation component mounting structures, and locations are set forth in order to provide a more thorough understanding of the present invention. It will be appreciated, however, by one skilled in the art that the invention may be practiced without such specific details.

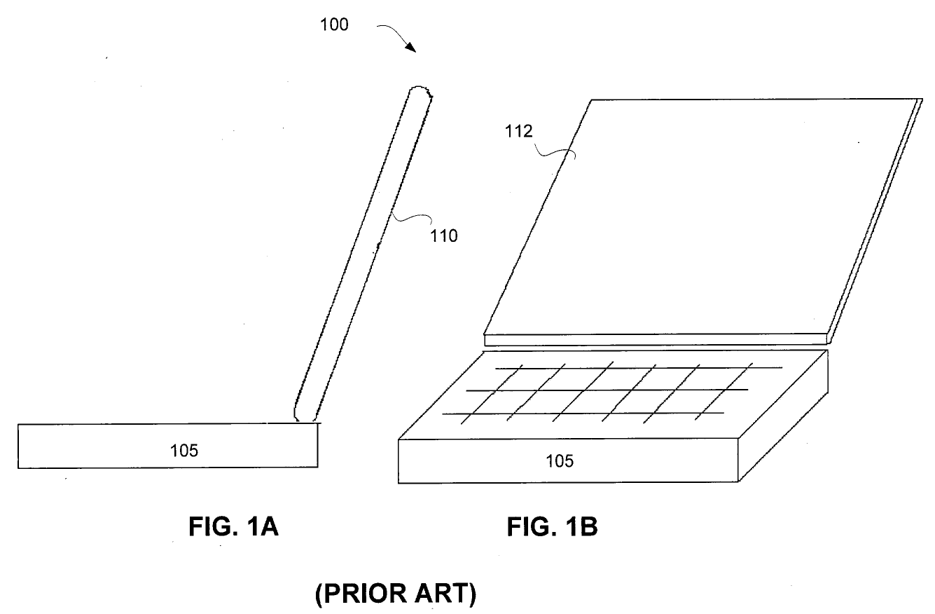

FIGS. 1A and 1B illustrate a side view and a front view of a prior art portable computing device. Portable computing device 100 may be a laptop computer, a notebook computer, or any other portable computing device. The portable computing device 100 may include a base unit 105 and a display unit 110. The display unit 110 may be attached to the base unit 105 using one or more attachment mechanisms (not shown) such as, for example, hinges. The portable computing device 100 may include many electronic components. These electronic components may include a memory system, a disk and/or CD ROM drive, audio and video hardware, connectivity (i.e., network and modem) hardware, a power supply, etc. Most of these electronic components may be in the base unit 105 instead of being in the display unit 110. Typically, the base unit 105 may include one or more cooling devices to reduce temperature. For example, the cooling devices may include heap pipes, heat exchangers, etc. The display unit 110 may include a display screen 112 which may be, for example, liquid crystals display (LCD).

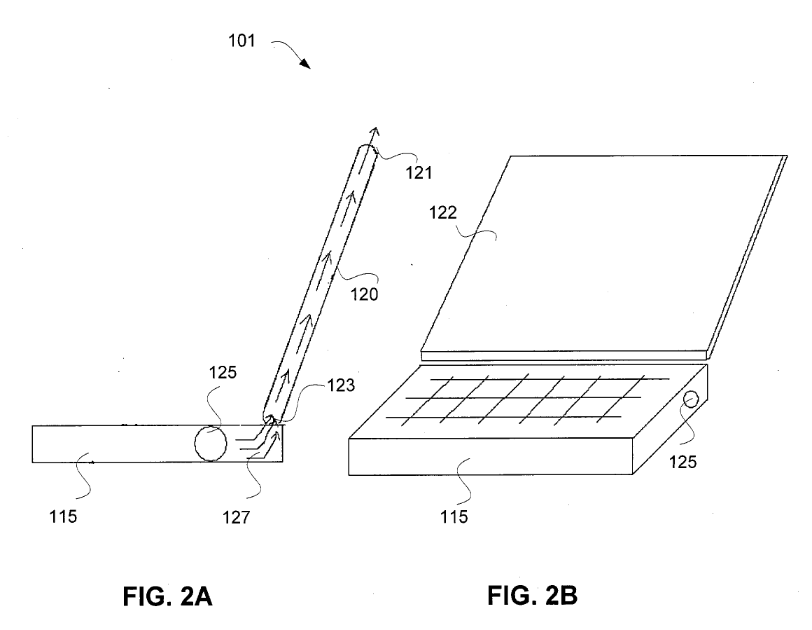

FIGS. 2A and 2B illustrate a side view and a front view of a portable computing device that includes an air movement device in a base unit, according to one embodiment. Portable computing device 101 may include a base unit 115 and a display unit 120. For one embodiment, the base unit 115 may include an air movement device 125. The air movement device 125 may be, for example, a fan, a blower, etc. The base unit 115 may also include one or more openings (not shown) to allow airflow 127 generated by the air movement device 125 to flow out of the base unit 115. In this example, the location of the air movement device 125 is for illustration only and may vary depending on the implementations.

For one embodiment, the display unit 120 may be an enclosure having a display screen 122 and electronic components associated with the display unit 120. Depending on the implementations of the portable computing device 101, the display unit 120 may also include other electronic components such as, for example, circuits, memory chips, batteries, processor, etc. The electronic components may be located behind the display screen 122. The display unit 120 may include one or more openings or vents 123 (may be referred to as entry openings) located at or near its bottom edge. The display unit 120 may also include one or more openings 121 located at or near its top edge (may be referred to as exit openings).

For one embodiment, when the entry openings 123 at or near the bottom edge of the display unit 120 is placed in a location having pressured airflow, the entry openings 123 may allow the pressured airflow to flow into the display unit 120 behind the display screen 122 to cool the electronic components in the display unit 120. In this example, the entry openings 123 is placed near the one or more openings (not shown) of the base unit 115 to receive the airflow 127 flowing out of the base unit 115.

For one embodiment, the airflow 127 generated by the air movement device 125 may have a pressure higher than the air released by the display unit 120. This may allow the airflow 127 to flow (in the direction illustrated by the arrows) into the display unit 120 at the entry openings 123 and out of the display unit 120 at the exit openings 121. For one embodiment, the air movement device 125 is positioned such that that the pressured air that flows into the display unit 120 is of a lower temperature than the ambient air within the display unit 120. As the air flows toward the exit openings 121, the air temperature may rise.

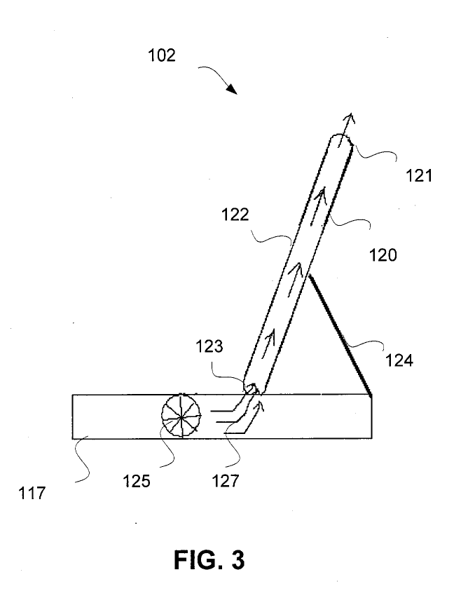

FIG. 3 illustrates a side view of another portable computing device that includes an air movement device, according to one embodiment. Portable computing device 102 may include a base unit 117 and a display unit 120. For one embodiment, the display unit 120 of the portable computing device 102 may be detachable from the base unit 117. In this example, the display unit 120 of the portable computing device 102 may be attached to the base unit 117 using attachment 124. The attachment 124 may also enable the display unit 120 to stay upright with respect to the base unit 117, as illustrated. Note that in this example, the air movement device 125 of the portable computing device 102 may be positioned at a different location comparing to the location illustrated in FIGS. 2A and 2B. This may allow the airflow 127 to enter the display unit 120 when the display unit 120 is positioned as shown in FIG. 3.

It may be noted that, in this example, because the display unit 120 may be detached from the base unit 117, the display unit 120 may include hardware logic to enable it to perform as a tablet computing device. The hardware logic may include, for example, memory subsystem, I/O subsystem, processor, etc. In this example, the base unit 117 may not include the same hardware logic as the base unit 105 of the portable computing device 100 illustrated in FIG. 1. For example, the base unit 117 may include a keyboard, one or more hard drives, etc.

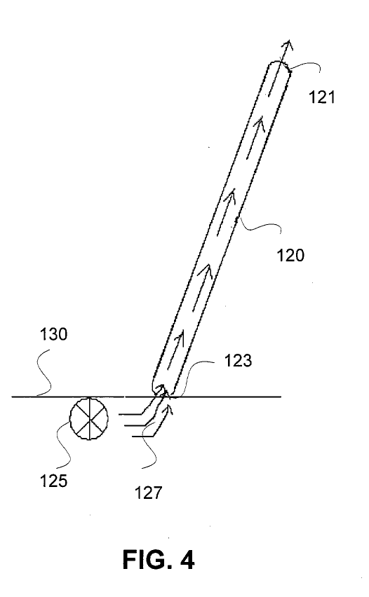

For one embodiment, when the display unit 120 is detached, cooling of the electronic components in the display unit 120 may be achieved by placing the display unit 120 on a surface that provides pressured air. FIG. 4 illustrates a tablet computing device, according to one embodiment. For one embodiment, the display unit 120 may include electronic components to enable it to perform as a tablet computing device. Surface 130 may have one or more openings (not shown) and an air movement device 125 underneath. The air movement device 125 may generate pressured air which may flow through the one or more openings of the surface 130. The display unit 120 may be positioned such that the pressured air 127 may enter the display unit 120 at the entry openings 123 near the bottom of the display unit 120.

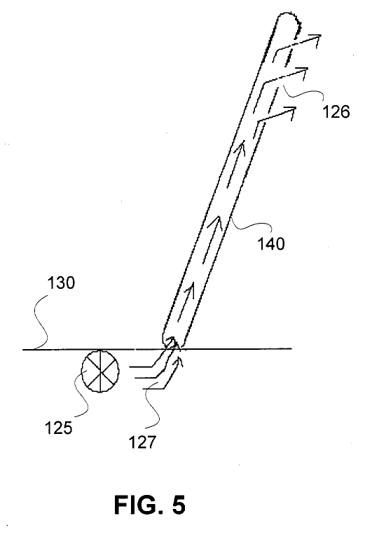

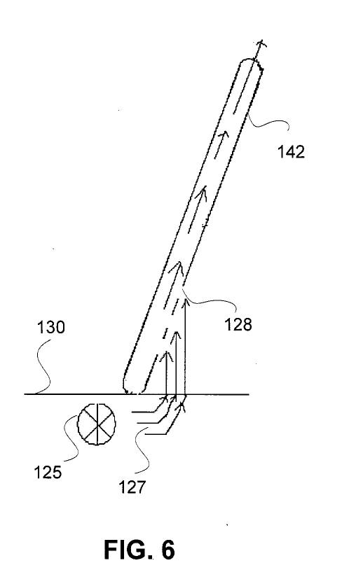

The entry openings 123 and the exit openings 121 on the display unit 120 may be positioned based on concentration of heat inside the display unit 120. For example, depending on how the electronic components are arranged in the display unit 120, certain areas (e.g., hot spots) may be warmer than others. Thus, it may be desirable to allow the airflow to flow past these areas when the air is still cool. This may help increase the overall cooling effectiveness of the airflow. FIG. 5 illustrates a tablet computing system that includes exit openings, according to one embodiment. Note that display unit 140 (which may perform as a tablet computing device) may include exit openings 126 on upper part of the back of the display unit 140, as compared to the exit openings 121 located at the top edge of the display unit 140. FIG. 6 illustrates a tablet computing device that includes entry openings, according to one embodiment. Note that display unit 142 (which may perform as a tablet computing device) may include entry openings 128 on lower part of the back of the display unit 142, as compared to the entry openings 123 being at the bottom edge of the display unit 142.

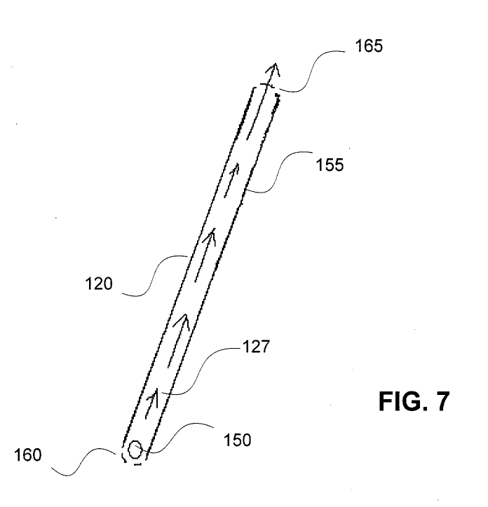

FIG. 7 illustrates a tablet computing device with an air movement device, according to one embodiment. For one embodiment, display unit 155 (which may perform as a tablet computing device) may include a display screen 120 and an air movement device 150 in an enclosure that makes up the display unit 155. The air movement device 150 may be positioned behind the display screen 120 and toward the bottom of the display unit 155. The display unit 155 may also include one or more openings 160 to enable the air movement device 150 to pull cool air from outside of the display unit 155. Air flow 127 generated by the air movement device 150 may cause an increase in pressure in the bottom region of the display unit 155 enabling the air to flow toward the exit openings 165 located toward the top of the display unit 155. This may help with heat dissipation of the electronic components in the display unit 155.

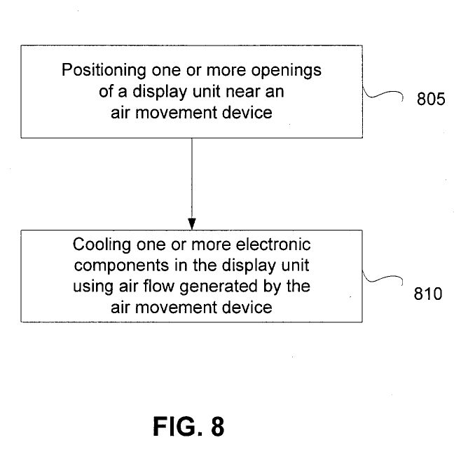

FIG. 8 is a flow diagram illustrating one process used to cool a display of a computing device, according to one embodiment. In this example, the display unit does not have its own air movement device and may rely on an external air movement device to help with its heat dissipation. At block 805, the display unit is positioned near an air movement device. To increase the amount of pressured air received from the air movement device, it may be desirable to position the entry openings of the display unit near the air movement device. At block 810, the electronic components in the display unit are cooled by the pressured air that enters the display unit at the entry openings and flows behind the display screen toward the exit openings of the display unit.

For one embodiment, when the display unit has its own air movement device or when it is attached to a base unit that has an air movement device, the display unit may include a temperature sensor that measures the temperature of the ambient air inside the display unit. The temperature sensor may be coupled to a temperature manager which manages the operation of the air movement device. One or more predetermined temperature thresholds may be used by the temperature manager to control the operation of the air movement device to provide more efficient thermal management.

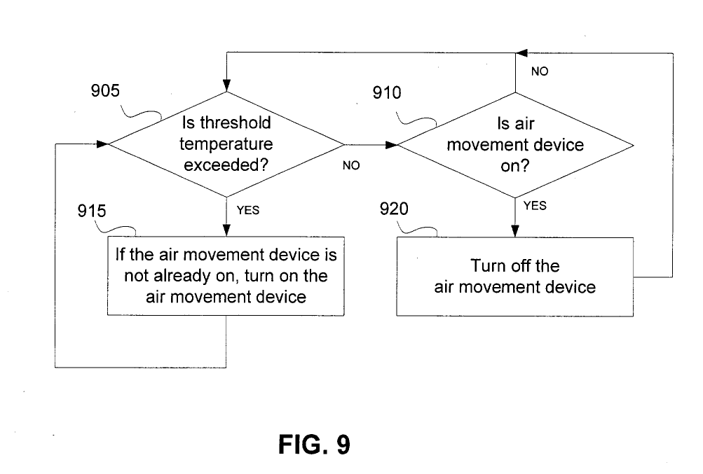

FIG. 9 is a flow diagram illustrating another process used to cool a display of a computing device, according to one embodiment. In this example, the display unit may have its own air movement device or it may be attached to a base unit that has an air movement device. At block 905, a test is made to determine if the temperature of the ambient air exceeds a threshold temperature. When the threshold is exceeded, the air movement device is turned on, as shown in block 915. It may be possible that the air movement device is already on but the temperature of the ambient air may still exceed the temperature threshold. From block 915, the process continues at block 905.

From block 905, when the temperature threshold is not exceeded, the process flow to block 910 where a test is made to determine if the air movement device is on. When the air movement device is on, the process flows from block 910 to block 920 where the air movement device is turned off to save power. From block 920, the process than continues to block 905. From block 910, when the air movement device is not on, the process flows from block 910 to block 905.

The operations of these various methods may be implemented by a processor in a computing device, which executes sequences of computer program instructions which are stored in a memory which may be considered to be a machine-readable storage media. For example, the computing device may be the portable computing device 102 illustrated in FIG. 3. The memory may be random access memory (RAM), read only memory (ROM), a persistent storage memory, such as mass storage device or any combination of these devices. Execution of the sequences of instruction may cause the processor to perform operations according to one embodiment the present invention such as, for example, the operations described in FIGS. 8-9.

This invention has been described with reference to specific exemplary embodiments thereof. It will, however, be evident to persons having the benefit of this disclosure that various modifications and changes may be made to these embodiments without departing from the broader spirit and scope of the invention. The specification and drawings are, accordingly, to be regarded in an illustrative rather than a restrictive sense.

What is claimed is:

1. A system, comprising:
a base unit having a cooling device; and
a display unit attached to the base unit and adapted to receive airflow generated by the cooling device.

2. The system of claim 1, wherein the display unit includes a first housing, the first housing including a first set of one or more openings to receive the airflow generated by the cooling device.

3. The system of claim 2, wherein the display unit further includes a display screen, the airflow generated by the cooling device flowing behind the display screen.

4. The system of claim 1, wherein the cooling device is a fan.

5. The system of claim 1, wherein the base unit includes a second housing, the cooling device located inside the second housing.

6. The system of claim 5, wherein the second housing includes a second set of one or more openings, the airflow generated by the cooling device flowing through the second set of one or more openings and the first set of one or more openings.

7. The system of claim 6, wherein the second set of one or more openings is positioned near the first set of one or more openings.

8. The system of claim 6, wherein the second set of one or more openings is positioned relative to the first set of one or more openings to increase the airflow received by the display unit.

9. The system of claim 6, wherein the cooling device is positioned relative to the second set of one or more openings to increase pressure of the airflow received by the display unit.

10. The system of claim 6, wherein the first housing includes a third set of one or more openings, wherein the airflow received by the display unit exits the display unit at the third set of one or more openings.

11. The system of claim 11, wherein the third set of one or more openings is positioned relative to the first set of one or more openings to increase heat dissipation of the display unit.

12. An apparatus, comprising:
a first enclosure, the first enclosure including an air movement device; and
a second enclosure coupled to the first enclosure, the second enclosure including heat-generating electronic components associated with a display screen, the second enclosure further including a first opening to receive airflow generated by the air movement device, the airflow is to cool the heat-generating electronic components in the second enclosure.

13. The apparatus of claim 12, wherein the second enclosure further includes a second opening to release the air received at the first opening.

14. The apparatus of claim 13, wherein the second opening is positioned away from the first opening to enable the airflow to cool more heat-generating electronic components.

15. The apparatus of claim 14, wherein the airflow flows from the first opening to the second opening behind the display screen.

16. The apparatus of claim 12, wherein the display screen is a liquid crystal display (LCD).

17. The apparatus of claim 12, wherein the airflow generated by the air movement device further cools heat-generating electronic components in the first enclosure.

18. An apparatus, comprising:
a housing, the housing including an air movement device, a first opening, a second opening, and electronic components associated with a display screen, the air movement device is to cause airflow to enter the housing through the first opening and to flow behind the display screen toward the second opening.

19. The apparatus of claim 18, wherein the housing further includes a processor and electronic components associated with the processor, the processor coupled to the display screen, wherein the airflow is to cool the electronic components associated with the display screen and the electronic components associated with the processor.

20. The apparatus of claim 18, wherein the air movement device is a fan, and the display screen is a liquid crystal display (LCD).

21. A display unit in a mobile computing device, comprising:
a display screen; and
a first set of one or more openings to receive pressured air caused by a cooling device, the air is to flow behind the display screen to a second set of one or more openings.

22. The display unit of claim 21, further comprising electronic components associated with the display screen, and wherein the pressured air is to cool the electronic components.

23. The display unit of claim 22, wherein the first set of one or more openings is positioned at a location where there is a high concentration of heat generated by the electronic components associated with the display screen.

24. The display unit of claim 22, wherein the second set of one or more openings is positioned relative to the first set of one or more openings to enable more cooling of the electronic components associated with the display screen.

25. A computer system, comprising:
a base unit, the base unit including an air movement unit to generate airflow; and
a display unit coupled to the base unit, the display unit including a display screen and a first opening, wherein the first opening is positioned close to the air movement unit to receive the airflow generated by the air movement unit.

26. The system of claim 25, wherein heat generated by electronic components associated with the display screen is cooled by the airflow received at the first opening.

27. The system of claim 25, wherein the display unit further includes a second opening to allow cross ventilation of the airflow received at the first opening.

28. The system of claim 25, wherein the base unit further includes a processor and electronic components associated with the processor, and wherein heat generated by the electronic components associated with the processor is cooled by the airflow generated by the air movement unit.

29. A method, comprising:
forcing air through a first set of one or more openings of a display unit housing into the display unit housing, the air generated by an air movement device external to the display unit housing and is to dissipate heat generated by one or more electronic components included in the display unit housing.

30. The method of claim 29, wherein the air exits the display unit housing through a second set of one or more openings.

31. The method of claim 29, wherein the display unit housing includes a display screen and electronic components associated with the display screen.

32. The method of claim 31, wherein the display unit housing further includes a processing unit.

33. The method of claim 29, wherein the air movement device is included in a base unit housing coupled to the display unit housing.

34. A method, comprising:
determining if temperature of ambient air inside a display unit housing exceeds a predetermined temperature threshold; and
when the temperature of the ambient air exceeds the predetermined temperature threshold and an air movement device associated with the display unit housing is not turned on, turning on the air movement device, wherein air generated by the air movement device is to enter the display unit housing through a first set of one or more openings, to flow behind a display screen of the display unit housing, and is to exit the display unit housing through a second set of one or more openings.

35. The method of claim 34, further comprising:
when the temperature of the ambient air does not exceed the predetermined temperature threshold and the air movement device is not turned off, turning off the air movement device.

36. The method of claim 34, wherein the air movement device is external to the display unit housing.

37. The method of claim 34, wherein the air movement device is internal to the display unit housing.

38. A computer readable medium containing executable instructions which, when executed in a processing system, causes the processing system to perform a method comprising:
determining if temperature of ambient air inside a display unit housing exceeds a predetermined temperature threshold; and
when the temperature of the ambient air exceeds the predetermined temperature threshold and an air movement device associated with the display unit housing is not turned on, turning on the air movement device, wherein are generated by the air movement device is to enter the display unit housing through a first set of one or more openings, to flow behind a display screen of the display unit housing, and is to exist the display unit housing through a second set of one or more openings.

39. The computer readable medium of claim 38, further comprising:
when the temperature of the ambient air does not exceed the predetermined temperature threshold and the air movement device is not turned off, turning off the air movement device.

40. The computer readable medium of claim 38, wherein the air movement device is external to the display unit housing.

41. The computer readable medium of claim 38, wherein the air movement device is internal to the display unit housing.
